(19) United States
(12) Patent Application Publication
(10) Pub. No.: US 2009/0208654 A1
(43) Pub. Date: Aug. 20, 2009

(54) CLEANING APPARATUS AND METHOD

(76) Inventor: David William MacFarlane, Nr Carnforth (GB)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/719,137

(22) PCT Filed: Nov. 10, 2005
(86) PCT No.: PCT/GB05/04325

§ 371 Date: Feb. 9, 2009

(30) Foreign Application Priority Data
Nov. 13, 2004 (GB) 0425120.3

(51) Int. Cl. B08B 7/00; B05C 5/00; B05D 3/00; B08B 1/00; B41F 23/00

(52) U.S. Cl. 427/299; 118/300; 134/104.1; 134/95.2; 134/9

(57) ABSTRACT

Printing apparatus (10) comprises support means to support a roll (14) (specifically a fabric) to be printed on. The fabric inevitably has loose material and such parts will reduce the quality of the final print on the surface. Three parts may include lint and dirt. Surface cleaning apparatus (30) locates upstream of the printing means (10) and comprises an adhesive or tacky surface (32) of a roller (31). The adhesive surface collects the loose lint particles but this inevitably reduces the effectiveness of the adhesive surface. Accordingly, the cleaning apparatus (30) comprise adhesive surface cleaning means to continually clean the adhesive surface. This means that the printing process is continual and there is no need to stop the printing process.

### FIELD OF THE INVENTION

The present invention relates to surface cleaning apparatus, an assembly comprising printing apparatus and surface cleaning apparatus and a method of cleaning a surface.

### BACKGROUND TO THE INVENTION

Printing apparatus for printing on fabrics and other surfaces are arranged to receive a roll or web of a material. The web of material inevitably has small parts of loose or separate material attached or supported thereon, for example dirt and lint. During the printing process such material reduces the quality of the print by masking part of the surface of the web to be printed. Accordingly, printing apparatus may include cleaning means to clean the surface of the web prior to printing. Such cleaning means may include a simple vacuum to suck up the loose material. However, this may not be very effective especially with material that is at least loosely attached or adhered to the surface of the web.

The cleaning apparatus may also include tacky rollers or belts which run over the surface of the web and pick up the loose material. However, the effectiveness of the tacky surface naturally decreases over time as material attaches to the surface of the roller or belt. These rollers or belts may be rejuvenated by removing the belt or roller and applying a new tacky surface. However, this results in stopping or interrupting the printing process and therefore is not efficient. Alternatively, a further roller may be substituted whilst the roller is rejuvenated. This therefore receives further apparatus and is also more liable to failure and still interrupts the printing process relatively frequently.

It is an aim of the present invention to overcome at least one problem associated with the prior art whether referred to herein or otherwise.

### SUMMARY OF THE INVENTION

According to a first aspect of the present invention there is provided surface cleaning apparatus comprising a cleaning surface comprising an adhesive surface in which the adhesive surface is arranged, in use, to contact a surface to be cleaned, the apparatus further comprising adhesive surface cleaning means wherein the adhesive surface cleaning means cleans at least a part of the adhesive surface, in use.

Preferably the adhesive surface cleaning means cleans a part of the adhesive surface whilst another part of the adhesive surface is cleaning a surface to be cleaned.

Preferably, the adhesive surface cleaning means continually cleans at least a part of the adhesive surface, in use.

Preferably, the adhesive surface cleaning means continually cleans a strip of the adhesive surface, in use. Preferably the length of the strip is greater than 1 mm and more preferably is greater than 2 mm. Preferably the length of the strip is less than 100 mm and more preferably is less than 30 mm. Preferably the length of the strip is greater than or equal to substantially 4 mm and may be less than or equal to substantially 10 mm.

Preferably the length of the strip is between 25 mm and 35 mm.

The adhesive surface cleaning means may continually clean a strip of the adhesive surface wherein the strip extends along the full length of the adhesive surface.

Preferably a part of the surface is being processed whilst another part of the surface is being cleaned by the surface cleaning apparatus. Preferably a part of the surface is being printed on whilst another part of the surface is being cleaned by the surface cleaning apparatus.

Preferably a part of the surface is being processed whilst the adhesive surface cleaning means cleans the adhesive surface.

Preferably a part of the surface is being printed on whilst the adhesive surface cleaning means cleans the adhesive surface.

The adhesive surface cleaning means may comprise fluid supply means. The fluid supply means preferably does not contact the adhesive surface.

Preferably the fluid supply means comprise water supply means. The fluid supply means may be arranged to supply water at ambient temperature. The fluid supply means may be arranged to supply water at a temperature of between 0° C. and 100° C. The fluid (water) supply means may supply fluid at a pressure of between 1 bar and 100 bar and preferably between 25 bar and 50 bar and more preferably of between 30 bar and 35 bar or 40 bar. The fluid (water) supply means may supply fluid at a rate of up to 20 litres per minute and preferably between 1 litre per minute and 3 litres per minute and more preferably at substantially 1.5 litres per minute.

The fluid supply means may comprise a nozzle. The nozzle may be arranged to disperse the fluid (or water) outwardly at an angle of between 15° and 80° and preferably at substantially 40′. The nozzle may comprise a V jet nozzle.

The fluid supply means (or nozzle) may be arranged, in use, to be spaced from the adhesive surface in the region of between 5 mm and 250 mm and preferably 10 mm and 100 mm and more preferably by substantially 40 mm.

The fluid supply means (or nozzle) may be at an angle in the region of 40′ and 80′ relative to the normal of the adhesive surface and preferably is substantially 60° relative to the normal of the adhesive surface.

Preferably the fluid supply means is located in a chamber. Preferably the fluid supply means is located in a vacuum 30 chamber. Preferably the vacuum chamber is arranged, in use, to remove contaminants removed from the adhesive surface.

The fluid supply means may supply the fluid at a pressure of greater than or equal to substantially 4 bar and may be less than or equal to substantially 6 bar. The fluid supply means supplies the fluid at substantially 6 bar. Preferably, the fluid supply means supplies fluid to the adhesive surface.

The fluid supply means may supply a vapour to a part of the adhesive surface. The fluid supply means may supply water vapour to a part of the adhesive surface. Preferably the fluid supply means may supply steam to a part of the adhesive surface. The temperature of the steam may be greater than 140° C. and may be less than 180° C. and may be substantially 160° C.

The adhesive surface cleaning means may comprise suction means. Preferably the adhesive surface cleaning means applies or directs a vacuum towards a part of the adhesive surface.

The strength of the suction is preferably 130 mbar. The strength of the suction maybe up to 250 mbar. The strength of the suction may be substantially 50 mbar or greater.

The flow rate of the suction is preferably 125 m³/hour. The flow rate of the suction may be up to 225 m³/hour.

The strength of the suction may be substantially 230 mbar. The flow rate of the suction may be greater than 300 m³/hour and may be less than 800 m³/hour.

The suction means may clean a part of the adhesive surface after the fluid supply means has cleaned a part of the adhesive surface.

The suction means may clean the adhesive surface before the fluid supply means has cleaned a part of the adhesive surface.

The adhesive surface cleaning means may comprise first suction means and second suction means. Preferably the first suction means is arranged to clean a part of the adhesive surface before the fluid supply means has cleaned the adhesive surface and the second suction means may be arranged to clean a part of the adhesive surface after the fluid supply means has cleaned a part of the adhesive surface.

The suction means is preferably angled towards the adhesive surface. Preferably the suction means is arranged to direct or apply a vacuum at an acute angle relative to the tangent of the adhesive surface. Preferably the suction means is arranged to direct or apply a vacuum at an acute angle which may be substantially 450 relative to the tangent of the adhesive surface.

The suction means may be arranged to direct or apply a vacuum at an angle normal to the adhesive surface or perpendicular to the tangent of the adhesive surface.

The suction means may create a vacuum within a chamber. The fluid supply means may locate in the chamber. The chamber may have drying means located therein. The chamber may have gas (air) supply means located therein and may have first gas (air) supply means and second gas (air) supply means located therein.

The suction means may be arranged to remove or extract excess fluid.

Preferably the fluid supply means is arranged to direct a fluid at an angle relative to the adhesive surface and preferably at an angle normal to the adhesive surface or perpendicular to the tangent of the adhesive surface.

The adhesive surface may comprises a continuous surface and preferably comprises a substantially cylindrical surface.

The adhesive surface may comprise the outer surface of a roller.

The adhesive surface may comprise an outer surface of a belt.

The roller may comprise a metal. The metal may be steel or aluminium.

The roller may be solid.

The roller may be hollow.

The roller may comprise a cushioned or resilient surface.

The roller may comprise a rubber coated compound.

The roller may comprise a hard surface.

The roller may comprise a plastics. The roller may comprise polypropylene or polyvinyl chloride.

The roller may comprise carbon fibre.

The adhesive surface may comprise an acrylic adhesive. The outer surface (below the adhesive surface) may comprise a rubber coated surface.

The adhesive surface comprises a waterproof adhesive that remains tacky after contact with water and/or steam.

Preferably the adhesive surface moves at substantially the same speed as movement of the surface to be cleaned.

The surface to be cleaned may be moving at greater than 2 m/min, in use. The surface to be cleaned may be moving at less than 90 m/min, in use.

Preferably movement of the surface to be cleaned is arranged to move the adhesive surface and preferably rotates the adhesive surface and/or roller.

Preferably the adhesive surface is urged towards the surface to be cleaned by urging means.

The urging means may be variable in order to vary the force or pressure with which the adhesive surface is urged towards the surface to be cleaned.

The adhesive surface cleaning means may be arranged to clean a part or section (strip) of a length of the adhesive surface.

The cleaning apparatus may comprise movement means to move the adhesive surface cleaning means and preferably moves the adhesive surface cleaning means along the length of the adhesive surface. Preferably the movement means continually moves the adhesive surface cleaning means, in use. Preferably the movement means comprises return means in order for the movement means to move the adhesive surface cleaning means back and forth along the length of the adhesive surface, in use.

The adhesive surface cleaning means may be mounted on a carriage. Preferably the speed of movement of the carriage is variable. The carriage may be arranged to move along a rail and preferably along two rails. Preferably the carriage moves along the length of the adhesive surface and preferably moves at a speed related to the rotational speed of the adhesive surface as provided by a roller and/or belt.

Preferably the surface cleaning apparatus cleans a surface to be printed on. Preferably, the surface cleaning apparatus cleans a surface of a web of material. Preferably the web comprises a web of fabric or a web of paper. Preferably, the web is arranged to move past the surface cleaning apparatus and more preferably below the surface cleaning apparatus.

Preferably the surface cleaning apparatus is arranged, in use, to remove particles and/or lint from the surface to be cleaned.

The apparatus may comprise drying means which may dry at least a part of the adhesive surface after cleaning and before contact with the surface to be cleaned.

The drying means may comprise air supply means and preferably comprises warm or hot air supply means. The temperature of the air may be between 90° C. and 120° C. The pressure of the air may be up to 1.3 bar and preferably is substantially 1.125 bar. The air may be delivered at a flow rate of up to 325 m³/hour and preferably at substantially 275 m³/hour.

The temperature of the air may be ambient temperature.

The drying means may comprise a nozzle. Preferably the nozzle comprises a slot to deliver hot air therethrough. The dimension of the slot may be variable.

The apparatus may comprise gas supply means and preferably comprises air supply means. Preferably the air supply means is arranged to supply air toward the adhesive surface and preferably is arranged to loosen matter adhered thereto. The gas supply means may comprise first gas supply means and second gas supply means. The first gas supply means may direct gas to a part of the adhesive surface prior to the area where fluid supply means supplies a fluid. The first gas supply means may supply gas to be substantially coincident with the fluid from the third supply means. The (second) gas supply means may supply a gas at an angle to the tangent of the adhesive surface and may supply gas at substantially 45° to the tangent of the surface. The second gas supply means may direct gas to a part of the adhesive surface having been cleaned by a fluid.

Preferably, the gas (air) supply means creates turbulence adjacent to the adhesive surface.

Preferably the adhesive surface cleaning means initially cleans a part of the adhesive surface with first suction means and then preferably with fluid supply means and then preferably with second suction means and then preferably the part of the adhesive surface which has been cleaned is at least partially dried and preferably totally dried by drying means.

Preferably the adhesive surface is supported by support means. Preferably the adhesive surface is removable from the support means.

Preferably the cleaning means is radially spaced around the adhesive surface generally along an arc relative to the adhesive surface.

Preferably the cleaning means is spaced around the adhesive surface.

According to a second aspect of the present invention there is provided an assembly comprising printing means and surface cleaning apparatus, wherein the surface cleaning apparatus is in accordance with the first aspect of the present invention.

Preferably the printing means is arranged in use to print on a surface and more preferably on a fabric. The printing means may be arranged, in use, to print on paper or other suitable material.

The printing means may comprise a plurality of printing screens and preferably, comprises a plurality of rotary printing screens.

Preferably the surface cleaning apparatus is arranged, in use, to clean the surface to be printed on prior to printing.

Preferably the printing means comprises a printing blanket.

According to a third aspect of the present invention there is provided a method of cleaning a surface comprises contacting the surface with an adhesive surface and cleaning the adhesive surface with adhesive surface cleaning means.

Preferably the method comprises continually cleaning at least a part of the adhesive surface, in use.

Preferably the method comprises cleaning a part of a surface whilst another part of a surface is being printed on.

Preferably the method comprises cleaning a part of an adhesive surface whilst another part of the adhesive surface is cleaning a surface.

Preferably the method comprises cleaning a part of a surface whilst another part of the surface is being processed and in particular is being printed on.

Preferably the method comprises supplying a fluid to the adhesive surface.

The method may comprise supplying a vapour to the adhesive surface.

Preferably, the method comprises supplying water to the adhesive surface.

Preferably the method comprises drying the adhesive surface and more preferably drying a part of the adhesive following the supply of a fluid to the adhesive surface.

Preferably the method comprises applying a vacuum to a part of the adhesive surface.

### BRIEF DESCRIPTION OF THE DRAWINGS

The present invention will now be described, by way of example only, with reference to the drawings that follow; in which:

FIG. 1 is a side view of an embodiment of printing apparatus including an embodiment of surface cleaning apparatus.

FIG. 2 is a cross-sectional view of an embodiment of surface cleaning apparatus.

FIG. 3 is a side view of an embodiment of surface cleaning apparatus.

FIG. 4 is a plan view of an embodiment of a surface cleaning apparatus.

FIG. 5 is a side view of part of another embodiment of printing apparatus.

FIG. 6 is a cross-sectional view of another embodiment of surface cleaning apparatus.

FIG. 7 is a cross-sectional view of a further embodiment of surface cleaning apparatus.

FIG. 8 is a side view of a preferred embodiment of surface cleaning apparatus.

FIG. 9 is a side view of a preferred embodiment surface cleaning apparatus in a lowered position.

FIG. 10 is a side view of a preferred embodiment of surface cleaning apparatus in a raised position.

FIG. 11 is a front view of a preferred embodiment of surface cleaning apparatus.

FIG. 12 is a schematic plan view of a nozzle of a preferred embodiment of fluid supply means.

FIG. 13 is a schematic view of a nozzle of a preferred embodiment of fluid supply means and a part of an adhesive surface.

FIG. 14 is a schematic side view of a nozzle of a preferred embodiment of fluid supply means.

### DESCRIPTION OF THE PREFERRED EMBODIMENTS

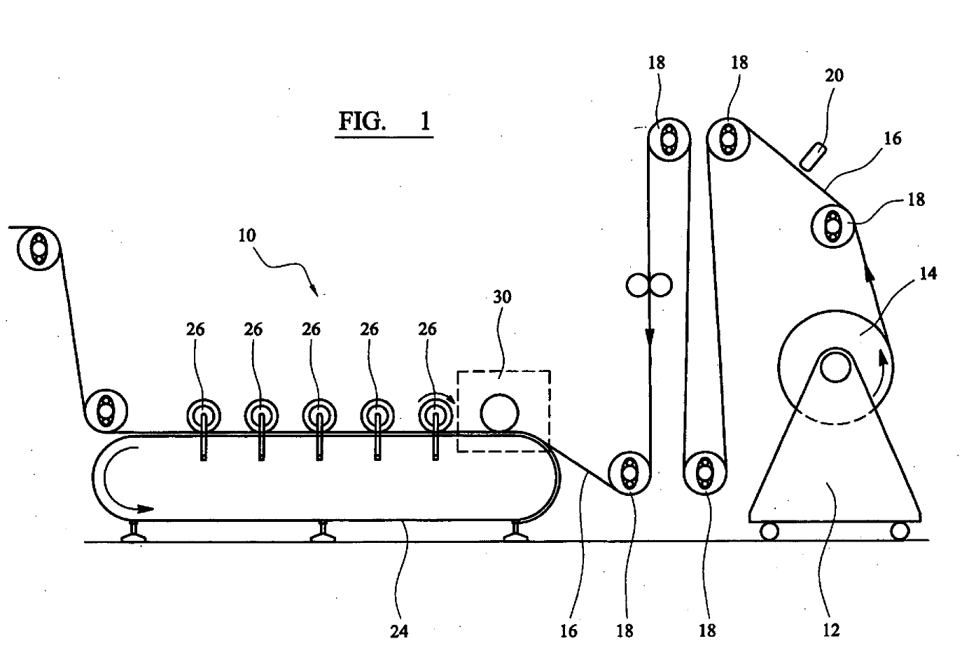

As shown in FIG. 1, printing apparatus 10 comprises support means 12 to support a roll 14 or web of a material to be printed on. Specifically the material 16 comprises a fabric to be printed on in order for use in curtains or other suitable use, for example upholstery. The material 16 may be another suitable material which is to be printed on or otherwise processed, for example, paper to create wall paper or any other suitable material which is to be printed on.

The roll of fabric is arranged to rotate in the support means 12 and the web 16 passes over a number of rollers 18 before passing under the printing means. The material 16 inevitably has loose material and other parts on the surface to be printed. As previously explained, such parts will reduce the quality of the final print on the surface. In fabrics, these parts may include lint and dirt.

The printing apparatus may include vacuum means 20 to simply remove free or very loose parts or fibres by suction. However, the vacuum means 20 will not remove parts or fibres that are relatively firmly attached to the surface and which may subsequently detach from the surface thereby reducing the quality of the print. Accordingly, the present invention provides surface cleaning apparatus 30 to improve the cleaning of the surface.

The surface cleaning apparatus 30 locates upstream of the printing means. In particular, the surface cleaning apparatus 30 locates above the printing blanket 24 at a location in front of the first printing screen 26. This position maximises the efficiency of the surface cleaning apparatus prior to printing.

As shown in FIG. 1, once the fabric 16 has been cleaned by the surface cleaning apparatus, the fabric 16 passes under the printing means which comprises rotary printing screens 26 and specifically five rotary printing screens. However, it will be appreciated that a different number of printing screens could be used, and could, for example, include up to 30 printing screens.

The fabric 16 is supported by the printing blanket 24 as the fabric 16 passes under the surface cleaning apparatus 30 and the rotary printing screens 26. Thereafter, the fabric 15 may pass over further rollers for further processing or for packaging.

As shown in FIG. 5, conventional printing apparatus 10 may comprise a thermal heater 100 to heat the fabric 16 prior to printing. The fabric 16 passes over the thermal heater 100 and underneath a first guide roller 102. The fabric 16 then passes between an upper tension roller 104 and a lower tension roller 106 and adheres to the printing blanket 24. The fabric 16 then passes below the first printing screen 26. In a preferred embodiment of the present invention, the surface cleaning apparatus 30 and in particular, an adhesive roller of the surface cleaning apparatus 30 is arranged to either replace the first guide roller 102 or the first printing screen 26 or the upper tension roller 104. Accordingly, the present invention can be installed on conventional printing apparatus 10. In one embodiment, a belt incorporating an adhesive surface could be used instead of an adhesive roller.

The actual position of the surface cleaning apparatus 30 may depend upon the design of the printing apparatus 10. When installed to replace the first guide roller 102, no contact with the printing blanket with the fabric 16 will be made. However, the adhesive roller is urged downwardly in order to ensure contact between the fabric and the adhesive roller.

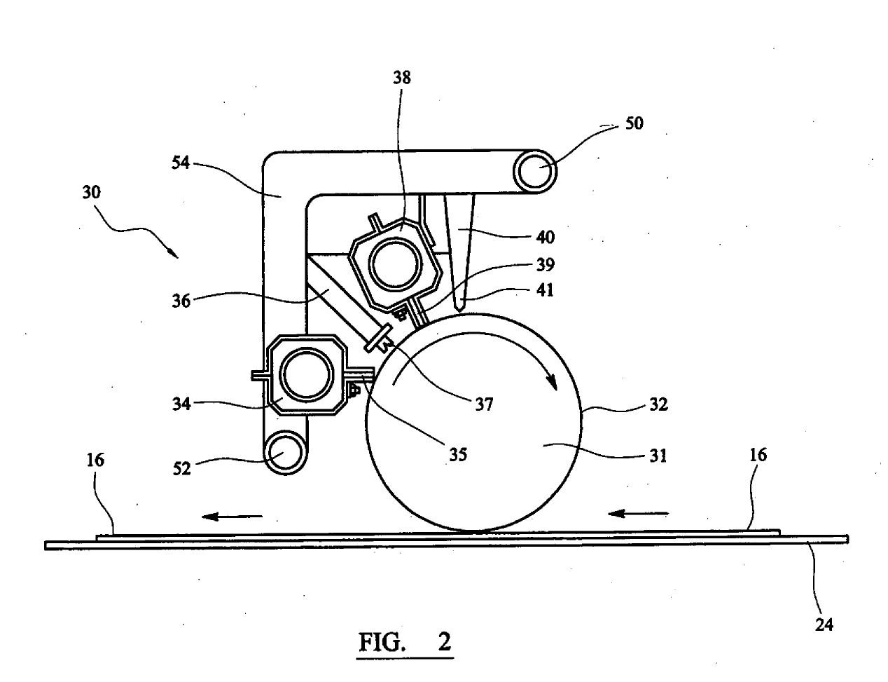

As shown in FIG. 2, the surface cleaning apparatus 30 comprises an adhesive (or tacky) surface 32 which contacts the upper surface of the fabric 16. In particular, the surface cleaning apparatus 30 comprises a roller 31 having an outer adhesive surface 32. The surface cleaning apparatus 30 comprises urging means to urge the adhesive surface downwards onto the surface of the material 16 to be cleaned.

The printing blanket 24 of the printing machine is driven and moves the fabric 16 under the cleaning apparatus 30 and the printing screens 26. The fabric 16 is held with the printing blanket 24 by temporarily adhering the fabric 16 to the printing blanket 24. Since the roller 31 is urged downwardly the movement of the fabric 16 and/or the printing blanket 24 is transferred through the fabric 16 and causes the roller 31 to rotate. Accordingly, the roller 31 does not require separate drive means. In addition, the transfer of drive ensures that the roller 31 rotates at the same velocity as the velocity of the fabric 16 and printing blanket 24. This ensures that each part of the fabric 16 is contacted by a renewed or cleaned part of the adhesive surface 32 of the roller 31.

As the adhesive surface 32 of the roller 31 contacts the surface of the fabric 16, lint particles, dust and dirt and other loose matter adhere to the adhesive surface 32 of the roller 31 which thereby cleans the surface of the fabric 16 to be printed.

As the roller 31 continues to rotate, the collection of lint and dirt causes the effectiveness of the adhesive surface 32 of the roller 31 to reduce. Accordingly, the cleaning apparatus 30 comprises adhesive surface cleaning means to clean the adhesive surface 32 of the roller 31. The adhesive surface cleaning means continuously cleans at least a part of the adhesive surface 32 of the roller 31 whilst the cleaning apparatus 30 and printing apparatus 10 are in use. Accordingly, part of the fabric 16 is being printed on whilst another part of the fabric is being cleaned whereby the adhesive surface 32 is also being cleaned to maintain its effectiveness. This is highly advantageous since this means that the printing process does not have to be stopped frequently to replace the roller and thereby reduces the “downtime” that this would cause. The fabric may travel through the printing apparatus 10 at between 2-90 metres per minute.

The adhesive roller may be hollow or solid with a hard or cushioned surface dependent upon the position of the roller and the application.

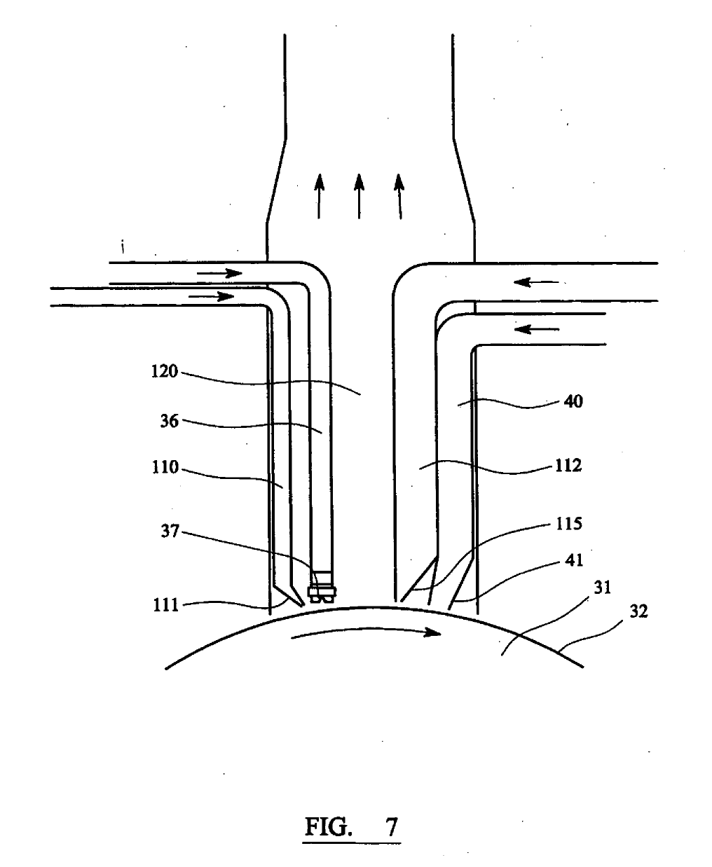

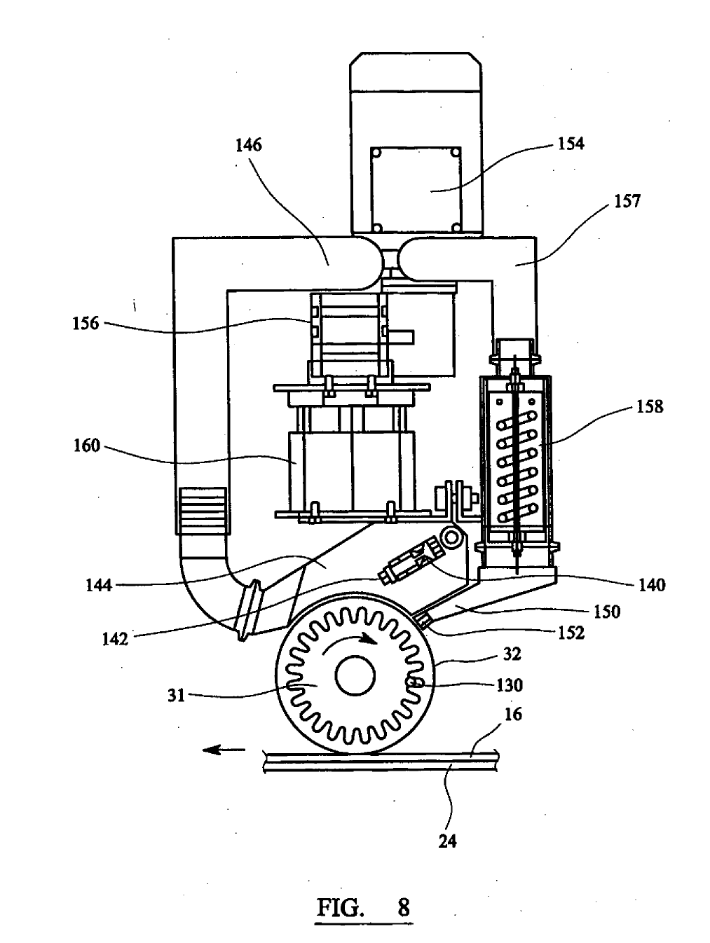

As shown in FIG. 2, the cleaning means for the adhesive surface 32 of the roller 31 comprises a number of different cleaning stages. Initially the cleaning means comprises suction means in the form of a vacuum 34 which is arranged to remove loose matter from the adhesive surface 32 of the roller 31. Thereafter, the cleaning means comprises fluid supply means 36 which is arranged to direct a fluid on to the adhesive surface 32 of the roller 31 to loosen further material on the adhesive surface 32 of the roller 31. The fluid may comprise steam (although in the preferred embodiment the fluid comprises water under pressure at ambient temperature, as shown in FIGS. 8 to 11 and described later on) and the excess steam (or water) is extracted by vacuum (in particular a second vacuum 38) and is then condensed and is removed with the lint and dust particles. The adhesive on the adhesive surface is preferably an acrylic adhesive or another suitable adhesive may be used. The adhesive remains tacky after cleaning and is not affected by water or steam. The cleaning means comprises a further suction means in the form of a vacuum 38 in order to remove the material loosened by the fluid. Finally, the cleaning means comprises drying means 40 to dry the adhesive surface 32 of the roller 31 prior to re-contacting the surface of the fabric 16 to be cleaned.

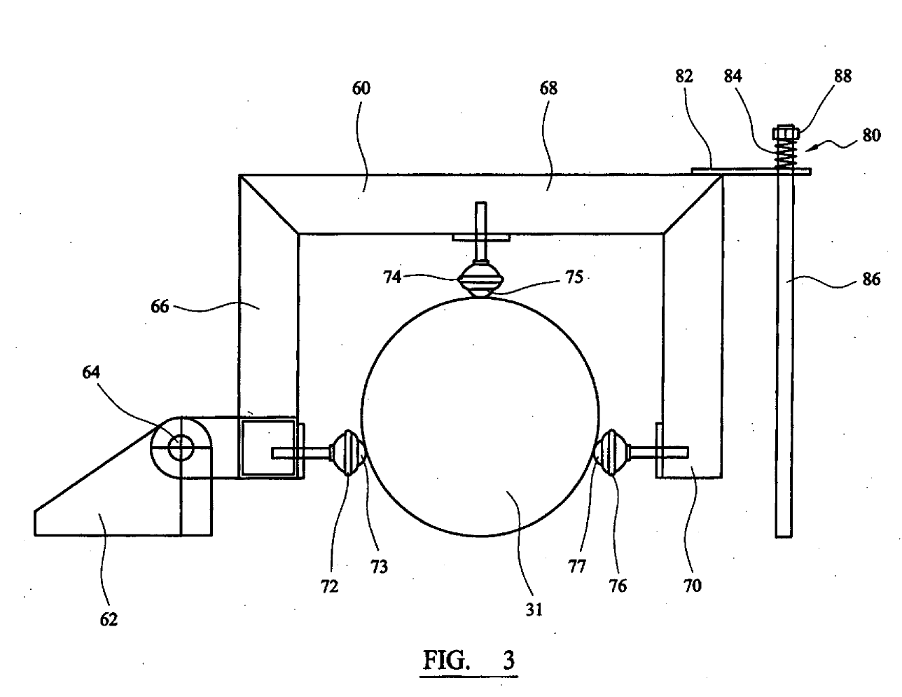

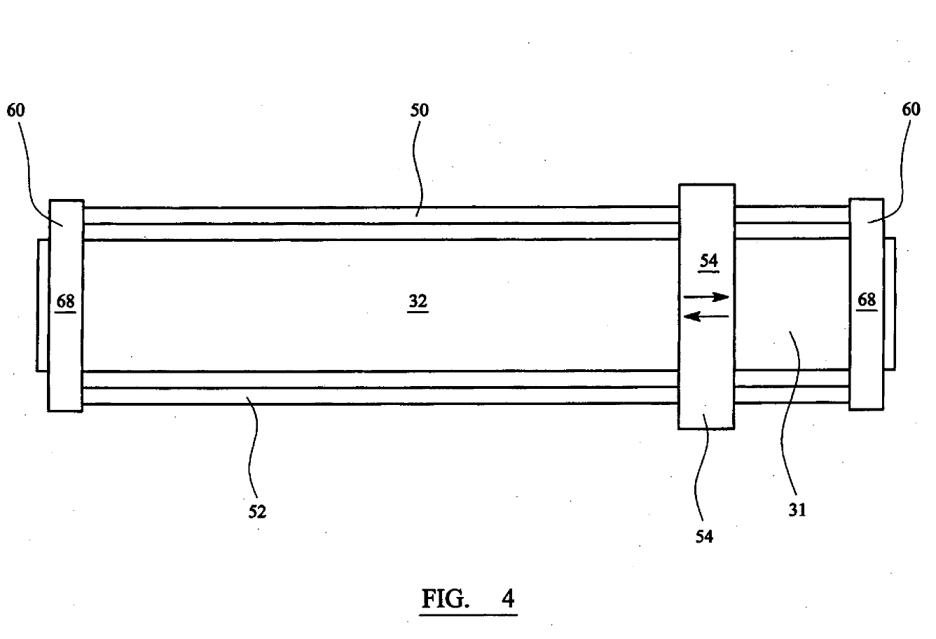

The cleaning means for an adhesive roller will now be described in more detail. The cleaning means includes support means to support the cleaning means and also to support the roller 31. The support means extends over the full length of the roller and comprises an upper support member 50 and a lower support member 52 (as shown in FIG. 4). As shown in FIG. 2 and FIG. 4, the cleaning means comprises a housing and specifically a carriage 54 which is mounted on to the support members 50, 52. The carriage 54 engages both support members 50, 52 and is movable across the length of the support members 50, 52.

As shown in FIG. 2, the carriage 54 supports the first vacuum 34. The vacuum apparatus or generator is located to one side of the machine and connection hoses transfer the vacuum to the first vacuum 34. The first vacuum comprises a nozzle 35 that is arranged, in use, to locate adjacent to the adhesive surface 32 of the roller 31 but not to contact the adhesive surface 32 of the roller 31. The nozzle 35 is spaced from the adhesive surface by substantially 2 mm. The vacuum may be substantially 230 mbar and have a flow rate of approximately 300-800 m³/hour. The nozzle 35 is arranged to direct or apply a vacuum at an angle relative to the adhesive surface 32 of the roller 31 and, in particular, the nozzle 35 is arranged to direct or apply a vacuum at an angle relative to the tangent of the adhesive surface 32 of the roller 31. In the preferred embodiment, the nozzle 35 is arranged to direct or apply a vacuum at an acute angle relative to the tangent of the adhesive surface, for example, an angle of substantially 45°.

The angle of the nozzle 35 helps to prevent any particles loosened by the fluid supply means 36 falling back on to the surface of the fabric 16.

Accordingly, the first vacuum 34 removes any loose particles on the adhesive surface 32 of the roller 31 and also prevents any particles subsequently unattached falling back on to the fabric 16.

The adhesive surface 32 of the roller 31 then passes under fluid supply means 36. The fluid supply means 36 is mounted on the carriage 54 and has a nozzle 37 to direct a fluid towards the adhesive surface 32 of the roller 31. Again, the nozzle 37 is spaced from the adhesive surface 32 of the roller 31 and does not contact the adhesive surface 32, in use. The nozzle 32 is spaced from the adhesive surface by substantially 2 mm.

The fluid supply means 36 is arranged to supply a fluid and in particular a jet of steam to the adhesive surface 32. The fluid supply means is provided with fluid from apparatus located to one side of the machine and connecting hoses connect the apparatus to the fluid supply means 36. The jet of steam is directed at an angle substantially normal to the adhesive surface 32 of the roller, i.e. the nozzle 37 is directed to supply the jet of steam substantially perpendicular to the tangent of the adhesive surface 32 of the roller 31. The steam jet loosens lint and dirt and other material adhered to the adhesive surface 32 of the roller 31. The nozzle is spaced from the adhesive surface by approximately 2 mm. The steam may be in the region of 140° C.-180° C. and preferably is 160° C. and is provided at a pressure in the region of 4-10 bar and preferably 6 bar. Some particles may fall down the adhesive surface 32 of the roller 31 and will be collected by the first vacuum 34. However, particles that are loosened or released may travel around on the rotation of the roller 31 and will be collected by a second vacuum 38.

The second vacuum 38 comprises a nozzle 39 which locates adjacent to but not in contact with the adhesive surface 32 of the roller 31. The vacuum may be 230 mbar and may have a flow rate of 300-800 m³/hour. The nozzle is spaced from the adhesive surface by substantially 2 mm. The vacuum apparatus or generator is located to one side of the machine and connecting hoses transfer the vacuum to the second vacuum 38. The second vacuum 38 is mounted on the carriage 54. The nozzle 39 is arranged to apply or direct a vacuum at an angle normal to the adhesive surface 32 of the roller 31 i.e. substantially perpendicular to the tangent of the adhesive surface 32 of the roller 31.

Finally, drying means 40 is arranged to dry the adhesive surface 32 of the roller 31 to remove any excess fluid so as not to dampen the fabric 16 in due course and also to increase the effectiveness of the adhesive surface 32. The air is supplied from apparatus located to one side of the machine and connecting hoses connect the apparatus to the drying means 40. The drying means 40 is mounted on the carriage 54 and extends downwardly towards the adhesive surface 32 to the roller 31. The drying means 40 comprises a nozzle 41 which locates adjacent to but spaced from (i.e. not in contact with) the adhesive surface 32 of the roller 31. The nozzle 41 is spaced from the adhesive surface by substantially 2 mm. The drying means 40 supplies air and in particular warm air or hot air to the adhesive surface 32 of the roller 31 in order to dry the adhesive surface 32. Any excess fluid may decrease the effectiveness of the adhesive surface and may also dampen the fabric.

The adhesive roller 31 continually rotates whilst being cleaned and after cleaning recontacts the fabric before being cleaned again. However, only a section of the adhesive surface 32 is cleaned on each rotation and, therefore, each part of the adhesive surface may contact the fabric 16 several times before being cleaned again. This prevents over-cleaning whereby the adhesive would relatively quickly loose its adhesion characteristics. In addition, this reduces the use of excessive fluids and also optimise the energy required for generating relatively small vacuums and air supply for the drying means. A strip or section of the adhesive roller 31 is cleaned and this strip may be in the region of 4-10 mm extending along the length of the adhesive surface. However, in one embodiment the cleaning means may extend over substantially the full length of the adhesive surface to clean a strip the adhesive surface 32 on each rotation of the roller.

The cleaning means only cleans a section or part of the adhesive surface 32 of the roller. The cleaning means moves along the length of the roller 31 in order to clean all of the adhesive surface 32 of the roller 31 over a predetermined time. In particular, each part of the adhesive surface 32 of the roller 31 will be cleaned for a period for the same length of time. In addition, each part of the adhesive surface 32 roller 31 will be cleaned as the cleaning means travels from left to right and then from right to left. This may further enhance the effectiveness of the cleaning means.

The cleaning means effectively cleans the whole adhesive surface 32 of the roller 31 in a spiral or helical pattern around the surface. The speed of movement of the carriage 54 can be adjusted depending upon the speed of rotation of the roller 31 to ensure all of the adhesive surface of the roller is cleaned and may be cleaned in a single movement of the carriage across the adhesive surface 32.

The cleaning means is mounted on a carriage 54 and includes movement means to moved the carriage 54 along the length of the support member 50, 52. The carriage 54 is moved by a variable speed motor through a toothed belt and slide mechanism. The carriage 54 includes sensing means to sense when the carriage is at an end of the support members 50, 52 which then reverses the movement means in order for the carriage 54 to travel in the opposite direction. The speed of the carriage is variable and can be set according to the amount of contaminants to be removed. However, the speed of the carriage is relatively slow and the carriage may travel once across the length of the adhesive surface every 30 seconds. The speed may be substantially in the region of 8 m/s with an adhesive roller which may have a length of 3-4 m. The diameter of the adhesive roller may also be dependent upon the use but typically may be 150 mm or 300 mm in diameter. It is appreciated that the greater diameter the less cleaning frequency of each part of the surface will be required.

The nozzles of the vacuums 34, 38, steam supply 36 and drying means may be slightly offset to accommodate for movement of the carriage whilst the adhesive surface is being cleaned i.e. the nozzles may be slightly offset in order to take into account the fact that the carriage may have moved relative to the adhesive surface and, therefore, the part of the adhesive surface which is cleaned by the first vacuum has moved before it reaches the second vacuum. In one embodiment the nozzles are of different sizes or are arranged to cover different sized areas or sections of the adhesive surface. In particular, the second vacuum covers a greater area width such that the second vacuum covers all of the area of the adhesive surface which has been cleaned by the steam.

As shown in FIG. 3 and FIG. 4, the cleaning means includes support means for supporting the roller 31. The support means comprises a frame 60 located towards each longitudinal end of the roller 31. The frame 60 is pivotally supported to a bracket 62 by a pivot 64. The frame 60 extends upwards above the printing blanket 24, over the width of the adhesive roller 31 and then extends back downwardly towards the printing blanket 24. The frame is effectively constructed from three separate frame members 66, 68, 70 forming a generally inverted U-shaped frame 60. The frame 60 supports bearing members 72, 74, 76 which are arranged to engage a section of the periphery of the roller 31 and preferably the roller 31 does not have an adhesive surface 32 around this section. The bearing members 72, 74, 76 engage the roller 31 to prevent translational movement of the roller 31 whilst allowing the roller 31 to freely rotate about the longitudinal axis of the roller 31. The arrangement of the support means or frame 60 is identical at each end of the roller.

Each bearing member 72, 74, 76 comprises a ball roller 73, 75, 77 partially located within a housing which allows the roller to rotate freely but is held in a predetermined position, for example the ball roller 73, 75, 77 can rotate in all planes but cannot move translationally relative to the respective housing.

The support means includes urging means 80 to urge the roller 31 downwards towards the printing blanket 24 in order to increase the effectiveness of the adhesive surface 32. The urging means 80 urges the frame 60 downwards by placing a pressure on the frame 60 at a location spaced from the pivot 64. Accordingly, the urging means 80 effectively urges the frame 60 to rotate about the pivot 64 which urges the roller 31 downwardly.

The urging means 80 comprises resilient means and an abutment member 82. The resilient means comprises a spring 84 which is mounted on a supported member 86. One end of the spring 84 is held in place by a stop 88 whilst the other end of the spring 84 is held in place by a part of the abutment member 82. The stop 88 is movable relative to the abutment member 82 in order to increase or decrease the length of the spring 84 which thereby varies the compressive force and increases or decreases the downwards pressure of the frame 60.

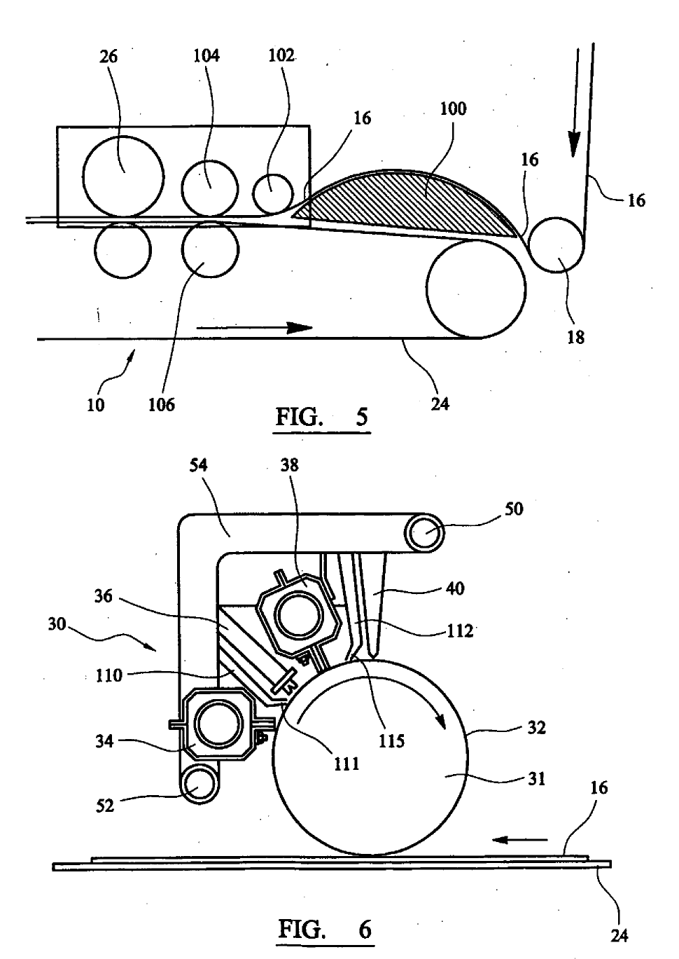

As shown in FIG. 6, another embodiment of the surface cleaning apparatus 30 comprise further fluid and specifically gas supply means in the form of air supply means 110, 112. The air supply means comprise first air supply means 110 and second air supply means 112. The first air supply means 110 comprise a nozzle 111 which is arranged to direct air towards the adhesive surface 32 at a location just before the steam (or water) supply to the adhesive surface or at a location substantially identical, coincident or superimposed on the location of the steam (or water) supply. The second air supply means 112 comprises a nozzle 115 which is arranged to supply air to the adhesive surface 32 after the adhesive surface 32 has passed under the steam supply 36 and possibly also underneath the second vacuum 38. The air supply means creates turbulence which enhances the removal of lint, dust and debris. In particular, this embodiment may remove substantially 6 mm of lint from the adhesive surface.

In a further embodiment of surface cleaning apparatus 30, a vacuum may be supplied over a relatively large area rather than through specific nozzles, as shown in FIG. 7. The steam (or water) supply, air supply means and the drying means may all locate within a vacuum and specifically within a vacuum chamber 120. As lint, dust and debris is removed or loosened on the adhesive surface 32, the vacuum removes such particles continually. In addition, the vacuum removes the excess steam from the steam supply 36. In addition, the adhesive surface cleaning apparatus is arranged to clean the top part or an uppermost arcuate section of the adhesive surface. This reduces the risk of contamination (i.e. lint, dust and dirt) discharging on to the fabric 16. This is further enhanced by the adhesive surface cleaning means including a vacuum chamber 120 throughout the cleaning phase.

The preferred embodiment of the present invention will now be described with reference to FIGS. 8 to 11 and may include identical apparatus and reference numbers which have already been described in detail.

The preferred embodiment of cleaning apparatus 30 comprises a roller 31 including a roller speed proximity counter 130.

The roller speed monitoring and calculation means comprises a proximity counter which is arranged to monitor and measure the rotational speed of the roller. The speed of the roller is then used to control the speed of the carriage or cleaning apparatus across the adhesive roller. The proximity counter comprises a sensor and in particular an optical sensor. A template, for example a template comprising a series of evenly separated spokes may be secured to one or both ends of the roller and the proximity counter will detect when a spoke registers with the proximity counter. Since the separation distance of the spokes is known the speed of the roller can be easily calculated and the speed of the carriage or head across the adhesive surface can be controlled and regulated.

The preferred embodiment of cleaning apparatus comprises fluid supply means 140 including a nozzle 142 which is arranged to direct water towards the adhesive surface 32 of the roller 31. The nozzle 142 and water supply means 140 is arranged to supply high pressure water and comprises a non-return valve. The fluid supply means 140, and in particular the nozzle 142, is located in a vacuum chamber 144. The vacuum is created through the supply line 146 which also removes and extracts the excess lint and debris etc. The vacuum chamber 144 has a lower perimeter or peripheral wall which is shaped to co-operate with the surface of the adhesive roller. Accordingly, the spacing between the lower wall or skirt of the vacuum chamber is evenly and uniformly spaced from the surface of the adhesive roller. This spacing enables air to enter into the vacuum chamber evenly. This spacing may be adjusted depending upon the application.

Again, the cleaning apparatus 30 includes drying means in the form of hot air discharge means 150 including a nozzle 152 to direct the hot air towards the cleaned adhesive surface 32 of the roller 31. The hot air is supplied through a conduit 157 which supplies the air from a high pressure air blower. The air is arranged to pass through an air heater 158 prior to supply through the nozzle 152.

The cleaning apparatus 30 comprises a variable speed drive unit 154 to vary and control the speed and movement of the cleaning apparatus 30 or more particularly of the carriage across the length of the adhesive coated roller 31. Again, the carriage is mounted on a lateral transverse mechanism 156 for this purpose.

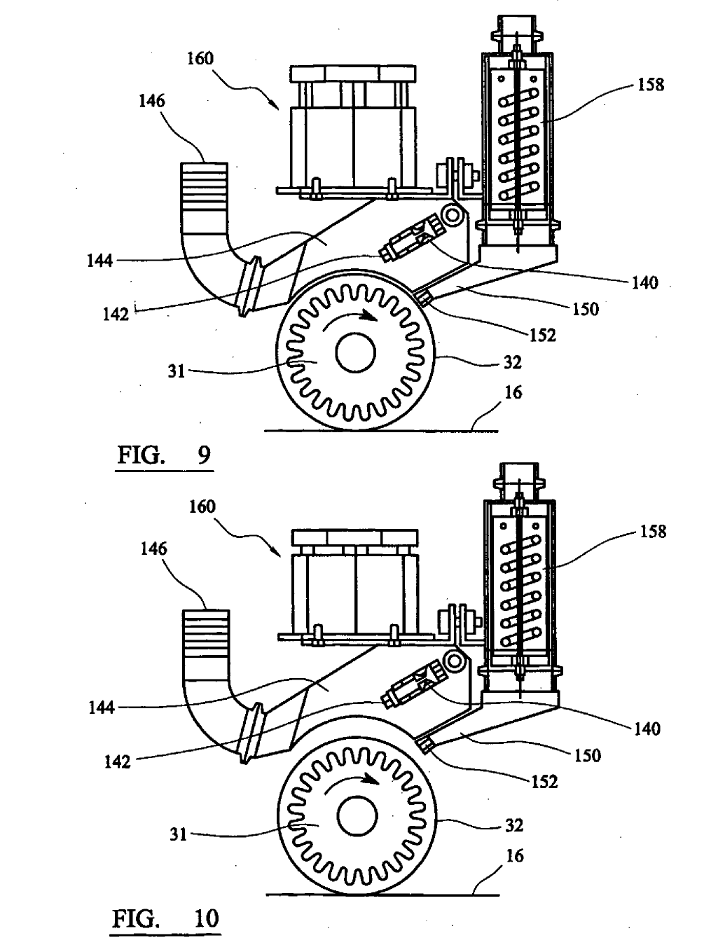

In addition, the cleaning apparatus 30 or carriage or more particularly, the vacuum chamber 144, water supply nozzle 152 and hot air nozzle are all mounted on a head which is movable by head movement means 160 in order for the head to move from a lowered position (as shown in FIG. 9) to a raised position (as shown in FIG. 10). Accordingly, the whole cleaning head can be moved away from the roller 31 when not in use.

As shown in FIG. 11, the services and supply lines 170 (for example, hot air and vacuum lines or conduits) are located centrally on a support frame 162 in order to constantly and uniformly maintain the supply to the carriage as the carriage moves over the length of the roller 31. The support frame 162 also comprises guards and covers to protect the mechanism of the present invention.

In the preferred embodiment, the fluid supply means 140 delivers high pressure water through the nozzle 142 at ambient temperature. The water is supplied at a pressure of between 25-50 bar with a water flow rate of between 1 and 3 litres per minute. In particular, the pressure is in the region of 30-35 bar and the water flow rate is 1.5 litres per minute.

The nozzle comprises a V-jet nozzle producing an angled spray, θ, of 40′, as shown in FIG. 12. However, the angle θ could be varied between 15° and 80° depending upon the application. The angled V jet spay from the nozzle is positioned for a horizontal spray pattern. Accordingly, when the water spray is viewed from above the water spray is dispersed outwardly from the nozzle, as shown in FIG. 12. However, when viewed from the side, the water spray is planar and is not dispersed in a V pattern, as shown in FIG. 14.

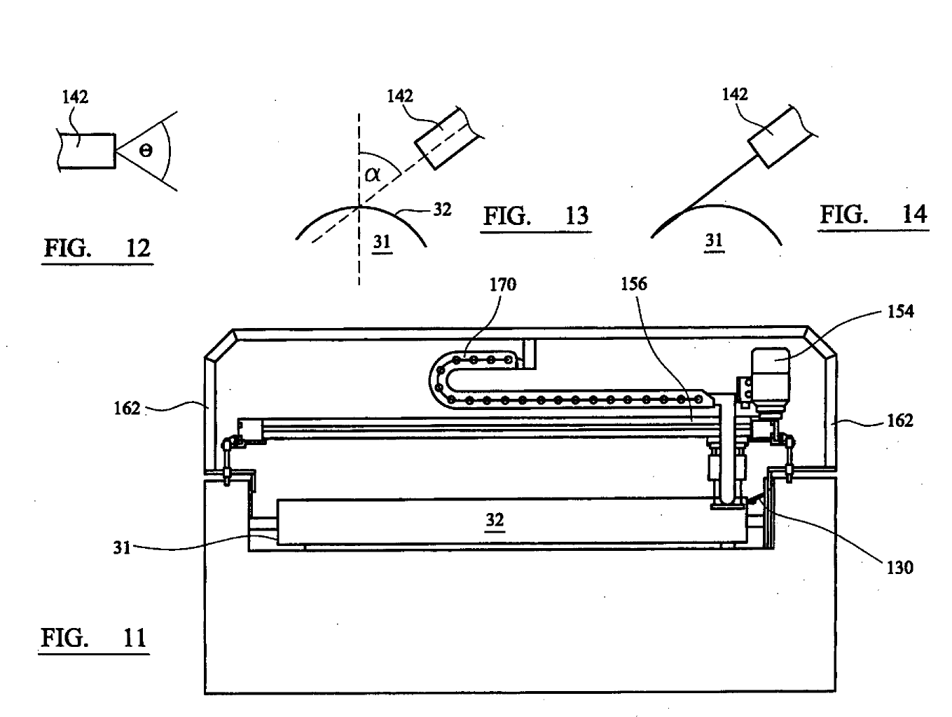

The exit part from the nozzle is positioned 40 mm from the surface of the roller although this may be variable between 10 and 100 mm, again depending upon the application. The nozzle is positioned at an angle of (a) of 60° relative to the surface of the adhesive roller (in particular to the normal of the upper part of the adhesive surface of the roller, as shown in FIG. 13). This angle, α, may be variable and in particular is variable between 40° and 80°. Both the position and the angle of the nozzle is changed when fitting a different V jet nozzle.

The cleaning strip per rotation is between 5 and 50 mm but more typically in this embodiment is between 25 and 35 mm.

The vacuum extract rate is 130 mbar with an air flow of 125 m³/h although this is variable up to 250 mbar and 225 m³/h. The whole wash chamber is under vacuum with air entering through the spacing between the wash chamber (or vacuum chamber 144) and the roller 31. This spacing is also variable between 2 and 10 mm but in the preferred embodiment is set at 4 mm to achieve optimum air speed movement.

A single air drier 150 is used to dry the roller 31 during rotation and this can deliver air at up to 1300 mbar (1.3 bar) at an air flow of 325 m³/hour. In the preferred embodiment this is set at 1125 mbar (1.125 bar) at 275 m³/hour.

Directly before the point of exit, air passes over an inline air heater 158 raising the temperature of the air to between 90° C. and 120° C. In one embodiment, the drying means may not include a heater and may use air at ambient temperature. The air then exits through a slot of dimensions 2 mm by 100 mm provided by the nozzle 152 which is positioned between 2 mm and 10 mm from the roller surface 32. The drying is achieved continually on each roller rotation and the air slot size in the nozzle 152 is variable between 1 mm and 5 mm. This obviously varies the air pressure and velocity on exit.

The cleaning apparatus 30 comprises control means to monitor and control the roller rotational speed so that the cleaning head can transverse across the roller at a speed that is directly proportional to the rotational speed, therefore, ensures a continual process and repeatable cleaning pattern.

The roller material may be any one (or combination) from a variety of materials as previously explained but the preferred embodiment is rubber coated with a natural rubber compound.

In a further embodiment, the cleaning apparatus may comprise a plurality of fluid supply means and, in particular, a number of fluid supply means all located with a single vacuum chamber. The cleaning apparatus may comprise a first fluid supply means and a second fluid supply means located within a single vacuum chamber. This may enable a greater length of strip of the adhesive surface to be cleaned.

In a yet further embodiment, the apparatus may comprise first cleaning apparatus and second cleaning apparatus wherein each cleaning apparatus comprises a head of carriage as previously described. Each carriage may be maintained on a single lateral transverse mechanism (or separate lateral transverse mechanism (and each may be controlled to extend over a portion of the adhesive roller. For example, one carriage may clean one half of the roller and the other carriage may clean the other lateral half of the roller. The carriages may be programmed to move from one end of the roller to the middle and then return. The carriages may be synchronised to meet in the middle or to never meet in the middle, for example one carriage may locate in the middle whilst the other is at the end of the roller and vice versa. The apparatus may comprise more than two carriages (e.g. a plurality of carriages) and it is appreciated that each may be programmed to clean a certain portion of the roller, e.g. if there are three carriages, each may clean one third and so forth.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments). The invention extends to any novel one, or any novel combination, of the features disclosed in this specification (including any accompanying claims, abstract and drawings), or to any novel one, or any novel combination, of the steps of any method or process so disclosed.

1. A surface cleaning apparatus comprising a cleaning surface comprising an adhesive surface wherein the adhesive surface is arranged, in use, to contact a surface to be cleaned, the apparatus further comprising adhesive surface cleaning means wherein the adhesive surface cleaning means cleans at least a part of the adhesive surface, in use.

2. A surface cleaning apparatus according to claim 1 wherein the adhesive surface cleaning means cleans a part of the adhesive surface while another part of the adhesive surface is cleaning a part of the surface to be cleaned and at the same time another part of the surface is being processed.

3. A surface cleaning apparatus according to claim 1 wherein the adhesive surface cleaning means comprises fluid supply means.

4. A surface cleaning apparatus according to claim 1 wherein the adhesive surface cleaning means comprises suction means.

5. A surface cleaning apparatus according to claim 4 wherein the adhesive surface cleaning means applies or directs a vacuum towards a part of the adhesive surface.

6. A surface cleaning apparatus according to claim 1 wherein the adhesive surface cleaning means comprises first suction means and second suction means wherein the first suction means is arranged to clean a part of the adhesive surface before the fluid supply means has cleaned said part of the adhesive surface and the second suction means is arranged to clean said part of the adhesive surface after the fluid supply means has cleaned said part of the adhesive surface.

7. A surface cleaning apparatus according to claim 1 wherein the adhesive surface comprises a continuous surface.

8. A surface cleaning apparatus according to claim 1 wherein the adhesive surface is urged towards the surface to be cleaned by urging means such that movement of the surface to be cleaned is arranged to move the adhesive surface.

9. A surface cleaning apparatus according to claim 1 wherein the apparatus comprises drying means to dry at least a part of the adhesive surface after cleaning and before contact with the surface to be cleaned.

10. A surface cleaning apparatus according to claim 1 wherein the adhesive surface cleaning means initially cleans a part of the adhesive surface with first suction means and then with fluid supply means and then with second suction means and then the part of the adhesive surface which has been cleaned is at least partially dried by drying means.

11. An assembly comprising printing means and a surface cleaning apparatus according to claims 1.

12. An assembly according to claim 11 wherein printing means is arranged in use to print on a fabric and the surface cleaning apparatus is arranged, in use, to clean the surface to be printed on prior to printing.

13. A method of cleaning a surface comprising contacting the surface with an adhesive surface and cleaning the adhesive surface with adhesive surface cleaning means.

14. A method according to claim 13 wherein the method comprises cleaning a part of the adhesive surface while another part of the adhesive surface is cleaning a part of the surface and at the same time printing on another part of the surface.

15-50. (canceled)
